(19) United States
(12) Patent Application Publication
(10) Pub. No.: US 2025/0256652 A1
(43) Pub. Date: Aug. 14, 2025

(54) VEHICLE INTERIOR MONITORING DEVICE

(71) Applicant: Continental Automotive Technologies GmbH, Hannover (DE)

(72) Inventors: Daniel Naujack, Frankfurt am Main (DE); Martin Gottwald, Babenhausen (DE)

(73) Assignee: Continental Automotive Technologies GmbH, Hannover (DE)

(21) Appl. No.: 19/038,931

(22) Filed: Jan. 28, 2025

(30) Foreign Application Priority Data
Feb. 12, 2024 (DE) 10 2024 201 249.1

(51) Int. Cl. B60R 1/29; B60K 35/22

(52) U.S. Cl. CPC B60R 1/29; B60K 35/22; B60K 2360/21; B60R 2300/8006

(57) ABSTRACT

The disclosure relates to a vehicle interior monitoring device, a vehicle interior monitoring system, and a display having a vehicle interior monitoring device. The vehicle interior monitoring device has a body transparent to a visible wavelength range, which has a plurality of surfaces and a plurality of edges. Surfaces of the body arranged adjacent are each at angles to one another. Furthermore, the vehicle interior monitoring device has a camera which operates in the visible wavelength range. The camera has an objective and an image sensor, wherein the objective is designed to project images on the image sensor. The body transparent to the visible wavelength range is arranged on the objective and body and objective are designed and arranged in relation to one another such that light incident on the objective passes a plurality of the surfaces of the transparent body placed at angles to one another.

### CROSS REFERENCE TO RELATED APPLICATIONS

This US patent application claims the benefit of German patent application No. 10 2024 201 249.1, filed Feb. 12, 2024, which is hereby incorporated by reference.

### TECHNICAL FIELD

The disclosure relates to a vehicle interior monitoring device, a vehicle interior monitoring system, a display having a vehicle interior monitoring device, and a vehicle which has such a vehicle interior monitoring device.

### BACKGROUND

Vehicle interior monitoring devices which use an RGB camera and are installed in the interior of a vehicle are known from the prior art. For example, installing a camera objective which projects color images on an image sensor behind a clear transparent windowpane is known. However, the camera or in particular the camera objective is thus visible to vehicle occupants and also clearly recognizable as such.

Problems of visibly installed cameras, in particular camera objectives, are accompanied by a lack of acceptance by vehicle occupants or drivers, since they can feel observed.

There are already solutions in which infrared cameras are installed behind surfaces, the material of which is only transparent for an infrared wavelength range, but not for wavelengths in the visible range. Such infrared cameras and their components, such as a camera objective, can therefore easily be concealed and hidden from the view of vehicle occupants behind corresponding surfaces.

### SUMMARY

The object of the disclosure is therefore to provide a vehicle interior monitoring device, which operates in the visible wavelength range and in which at least a part thereof is concealed or hidden such that at least this part is not directly visible and recognizable as a camera to vehicle occupants.

This object is achieved by a vehicle interior monitoring device, a vehicle interior monitoring system, and a vehicle according to the claims. Preferred embodiments of the disclosure are the subject matter of the claims.

According to a first aspect of the present disclosure, a vehicle interior monitoring device has a body transparent to the visible wavelength range, which has a plurality of surfaces and a plurality of edges. In this body, surfaces of the body arranged adjacent are at angles to one another. In other words, in this body, surfaces of the body arranged adjacent are arranged at angles to one another. The surfaces and edges may thus be placed in relation to one another such that light which is incident on the body is repeatedly refracted and an interior of the body is concealed or hidden. Furthermore, the vehicle interior monitoring device has a camera which operates in the visible wavelength range. The camera has an objective and an image sensor. The objective is designed to project images on the image sensor. Both the objective and the image sensor are designed for the visible wavelength range and are operated therein. The images projected on the sensor can be forwarded by the sensor as information, in particular as pixel image information, for example, to a computing unit such as a processor for further processing of the information. Furthermore, the body transparent to the visible wavelength range is arranged on the objective, so that the body is arranged between the objective and a vehicle occupant. Transparent body and objective are designed and arranged in relation to one another here such that light incident on the objective passes a plurality of the surfaces of the transparent body placed at angles to one another. Incident light is therefore refracted differently at the surfaces at angles to one another and supplies information from incident light which comes from different directions in a single image.

The objective and preferably the entire camera is concealed behind the transparent body or hidden thereby due to the plurality of surfaces placed at angles to one another such that at least the objective is not directly visible to vehicle occupants and recognizable as part of a camera. The camera objective or the camera is thus concealed such that a vehicle occupant no longer perceives the camera or at least parts of the camera such as the objective as such. Nonetheless, the camera has an unrestricted view of the interior and the occupants through the body. A camera which operates in the visible wavelength range may therefore be concealed very easily in the interior of a vehicle.

For example, the camera may be installed behind the transparent body on the dashboard at a display, such as a central display, or also at a display or an instrument cluster behind the steering wheel. It may be part of the instrument panel or may be used at another reasonable point in the vehicle, for example, as an application on a display screen.

According to one embodiment of the present disclosure, the transparent body has the form of a crystal or diamond. One advantage of a body designed in such a manner is that the body represents an eyecatcher in the vehicle, which is gladly observed. Such a body may be placed deliberately in the vehicle and embodied as a design element, may have a particular appeal and thus may upgrade the interior of the vehicle. The body may be both a real part (crystal, diamond) or also a body consisting of a different material which has a corresponding shape. The body may be, for example, a body ground from a glass in the form of a diamond and may be part of the instrument panel of a vehicle or may be used at another reasonable point in the vehicle, for example, as an application on a display screen. The objective and advantageously the entire camera remain concealed behind the body due to the design thereof, however.

According to a further embodiment of the present disclosure, the transparent body has a cavity in which at least the objective is arranged. The objective may be concealed even more easily behind or in the transparent body due to such a design. Moreover, due to this design the objective protrudes somewhat out of the plane on which the transparent body is arranged, so that the objective may cover a larger angle range.

According to still a further embodiment of the present disclosure, body and objective are designed and arranged in relation to one another such that at least one of the plurality of surfaces is aligned in the direction of at least one occupant. The plurality of surfaces may be designed such that the refraction of the incident light by the surfaces is utilized so as to be able to monitor various areas of the vehicle interior. For example, in particular multiple vehicle occupants may thus be monitored simultaneously. It is thus possible, for example, to design the surfaces of the body as angled such that, for example, a camera installed at a central display may observe both the driver and the front passenger. For example, the body may be designed as faceted having a plurality of surfaces arranged like facets. The faceted surfaces may be embodied here such that the objective or the entire camera is no longer perceived as such behind the transparent body.

According to a further aspect, the present disclosure relates to a vehicle interior monitoring system having an above-described vehicle interior monitoring device and a processor which is designed to receive information from the image sensor and process it. Because the transparent body and the objective of the vehicle interior monitoring device are designed and arranged in relation to one another such that the objective is aligned on a plurality of surfaces of the body placed at angles to one another, light incident on the transparent body is refracted differently at the surfaces at angles to one another. Information which comes from incident light from different directions is thus recorded in a single image received by the sensor. The processor may be designed, for example, programmed or contain a program, so as to process this information from incident light from different directions such that multiple items of information from different spatial angles may be provided deliberately from information of even a single image which the sensor provides, for example, to monitor a driver and a front passenger or additionally different points in the vehicle interior simultaneously.

In one embodiment, the processor may be designed and configured so as to decompose and prepare a single item of received image information into individual images such that at least one first single image has information about the driver and at least one second single image has information about a second vehicle occupant or the vehicle interior.

According to a further aspect, the present disclosure relates to a display having an above-described vehicle interior monitoring device. Displays for vehicles may be upgraded further in their appearance by the above-described vehicle interior monitoring device. A camera concealed in this manner on the display enables a higher acceptance in the case of an above-described upgrade of an appearance of such a display.

According to still a further aspect, the present disclosure relates to a vehicle having an above-described vehicle interior monitoring device, an above-described vehicle interior monitoring system, and/or an above-described display having vehicle interior monitoring device.

### BRIEF DESCRIPTION OF THE FIGURES

The disclosure is explained in more detail below on the basis of the figures.

In the figures:

FIG. 1 shows a side view of a first embodiment of a vehicle interior monitoring device,

FIG. 2 shows a perspective view of a body of the embodiment in FIG. 1,

FIG. 3 shows a perspective view of an interior of a front area of a vehicle having a vehicle interior monitoring device according to FIG. 1 installed on a central display, which is designed as a part of a vehicle interior monitoring system, and

FIG. 4 shows front views of different embodiments of a body for a vehicle interior monitoring device.

### DETAILED DESCRIPTION

For a better understanding of the principles of the present disclosure, embodiments of the disclosure are explained in more detail below with reference to the figures. Identical reference signs are used for identical or functionally identical elements in the figures and are not necessarily described again for each figure. It goes without saying that the disclosure is not restricted to the embodiments represented and that the features described may also be combined or modified without departing from the scope of protection of the disclosure as defined in the appended claims.

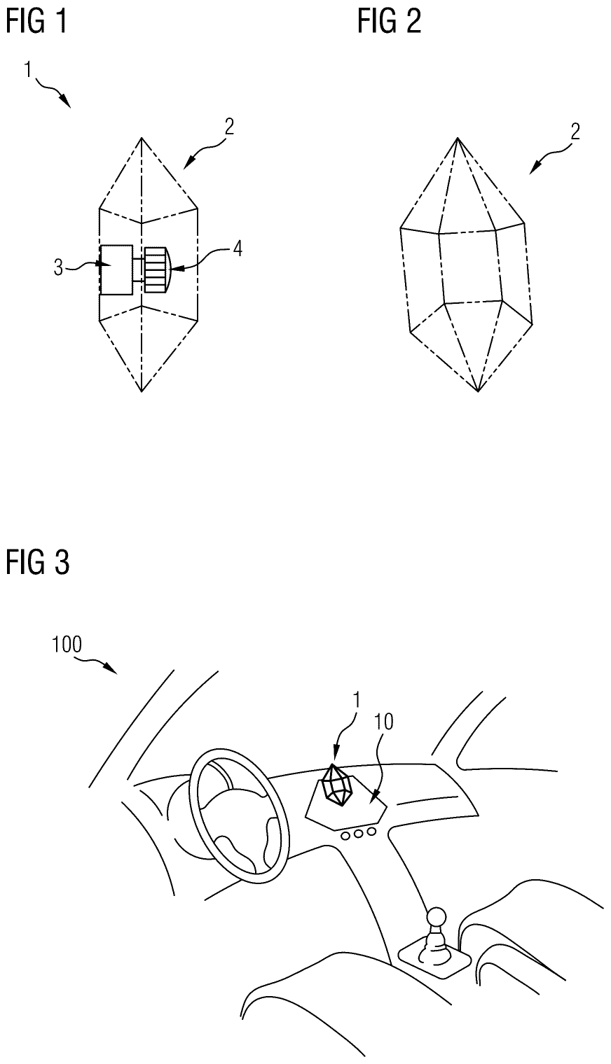

FIG. 1 shows a side view of a first embodiment of a vehicle interior monitoring device 1. The vehicle interior monitoring device 1 has a body 2, which is transparent to the visible wavelength range and which is shown in a perspective view in FIG. 2. As is apparent, the body has a plurality of surfaces and a plurality of edges, wherein surfaces of the body 2 arranged adjacent are arranged at angles to one another at their common edge, thus are nonparallel. The body 2 is ground from a glass and looks like a diamond, which may be incorporated harmoniously into an interior design of a vehicle. Further design and grinding options for a transparent body are shown in FIG. 4.

Furthermore, the vehicle interior monitoring device 1 in FIG. 1 has a camera 3 having an objective 4 and an image sensor (not visibly shown). The camera 3 operates in the visible wavelength range. In other words, the image sensor is sensitive in the visible wavelength range and the objective 4 is designed to project images in the visible wavelength range on the image sensor. The body 2 transparent to the visible wavelength range has a cavity, in which the objective 4 is arranged. The body 2 transparent to the visible wavelength range is therefore arranged on the objective 4 such that the objective 4 is arranged on a side of the body 2 facing away from a vehicle occupant.

Body 2 and objective 4 are moreover designed and arranged in relation to one another such that light incident on the objective 4 passes a plurality of the surfaces of the body placed at angles to one another. Furthermore, the body 2 and the objective 4 are designed and arranged in relation to one another such that at least one of the plurality of surfaces is aligned in the direction of at least one vehicle occupant.

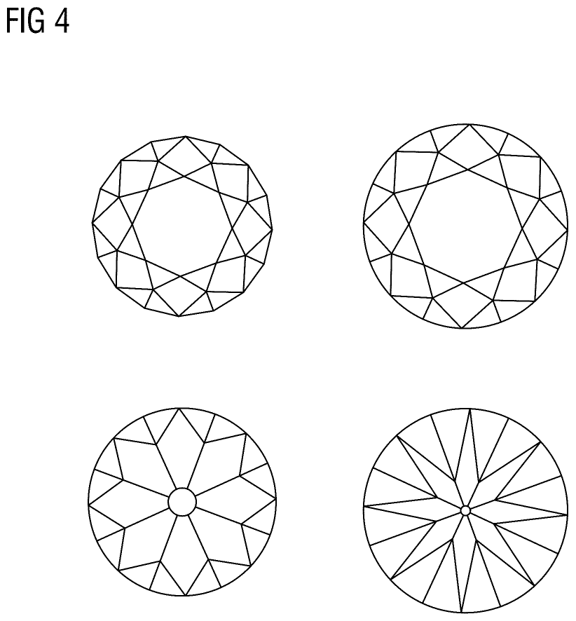

FIG. 3 is a perspective view of an interior of a front area of a vehicle 100 having a vehicle interior monitoring device 1, which is shown in FIG. 1, installed on a display 10, here a central display. The vehicle interior monitoring device 1 shown in FIG. 3 is part of a vehicle interior monitoring system (not shown in more detail). The vehicle interior monitoring system has the vehicle interior monitoring device 1 and additionally a processor (not shown). The processor is designed to receive information from the image sensor and process it. In particular, the processor is designed and configured so as to decompose and prepare a single item of received image information into individual images such that at least one first single image has information about the driver and at least one second single image has information about a second vehicle occupant or the vehicle interior.

For example, the image sensor records an image of the vehicle interior without driver, which the processor stores as a reference image. If a driver is located in the vehicle interior, the reference image is subtracted from the image information currently supplied by the image sensor. The processor then evaluates the differential information, which essentially contains image information originating from the driver. A further reference image of the vehicle interior with driver is also stored, which is then used when a further vehicle occupant is added. A corresponding procedure may be used upon further changes of the occupancy of the vehicle interior. A specially designed image sensor and/or a specially designed objective may be omitted due to this or other suitable evaluation or post-processing of the image information in the processor. Instead, cost-effective standard components may be used.

1. A vehicle interior monitoring device, comprising:
a body transparent to a visible wavelength range, which has a plurality of surfaces and a plurality of edges, wherein surfaces of the body arranged adjacent are each at angles to one another, and
a camera, which operates in the visible wavelength range, having an objective and an image sensor, wherein the objective is designed to project images on the image sensor,
wherein the body transparent to the visible wavelength range is arranged on the objective, and
wherein the body transparent to the visible wavelength range and objective are designed and arranged in relation to one another such that light incident on the objective passes a plurality of the surfaces of the body placed at angles to one another.

2. The vehicle interior monitoring device as claimed in claim 1, wherein the body transparent to the visible wavelength range has the form of a crystal or a diamond.

3. The vehicle interior monitoring device as claimed in claim 1, wherein the body transparent to the visible wavelength range has a cavity, in which at least the objective is arranged.

4. The vehicle interior monitoring device as claimed in claim 1, wherein the body transparent to the visible wavelength range and the objective are designed and arranged in relation to one another such that at least one of the plurality of surfaces is aligned in the direction of at least one vehicle occupant.

5. A vehicle interior monitoring system comprising:
a vehicle interior monitoring device, comprising:
a body transparent to a visible wavelength range, which has a plurality of surfaces and a plurality of edges, wherein surfaces of the body arranged adjacent are each at angles to one another, and
a camera, which operates in the visible wavelength range, having an objective and an image sensor, wherein the objective is designed to project images on the image sensor,
wherein the body transparent to the visible wavelength range is arranged on the objective,
wherein the body transparent to the visible wavelength range and objective are designed and arranged in relation to one another such that light incident on the objective passes a plurality of the surfaces of the body placed at angles to one another, and
a processor which is designed to receive information from the image sensor and process it.

6. The vehicle interior monitoring system as claimed in claim 5, wherein the processor is designed and configured so as to decompose and prepare a single item of received image information into individual images such that at least one first single image has information about the driver and at least one second single image has information about a second vehicle occupant or the vehicle interior.

7. A display, comprising:
a vehicle interior monitoring device, comprising:
a body transparent to a visible wavelength range, which has a plurality of surfaces and a plurality of edges, wherein surfaces of the body arranged adjacent are each at angles to one another, and
a camera, which operates in the visible wavelength range, having an objective and an image sensor, wherein the objective is designed to project images on the image sensor,
wherein the body transparent to the visible wavelength range is arranged on the objective, and
wherein the body transparent to the visible wavelength range and objective are designed and arranged in relation to one another such that light incident on the objective passes a plurality of the surfaces of the body placed at angles to one another.
